(19) United States
(12) Patent Application Publication
(10) Pub. No.: US 2010/0283179 A1
(43) Pub. Date: Nov. 11, 2010

(54) Method of Fabricating Metal Nitrogen Oxide Thin Film Structure

(75) Inventors: Zih-Sian Lu, Taoyuan (TW); Keng-Shen Liu, Taoyuan (TW); Wen-Biing Ou Yang, Taoyuan (TW); Chih-Hung Wu, Taoyuan (TW)

Correspondence Address: LEE & HAYES, PLLC, 601 W. RIVERSIDE AVENUE, SUITE 1400, SPOKANE, WA, 99201, US

(73) Assignee: ATOMIC ENERGY COUNCIL-INSTITUTE OF NUCLEAR ENERGY RESEARCH, TAOYUAN (TW)

(21) Appl. No.: 12/690,264

(22) Filed: Jan. 20, 2010

(30) Foreign Application Priority Data
May 7, 2009 (TW) 098115080

(51) Int. Cl. B29C 71/02

(52) U.S. Cl. 264/235

(57) ABSTRACT

A TiON, TaON or ZrON thin film is fabricated through an easy process. The film is corrosion resistant, electric conductive and decorative. The process uses no chloride (Cl) and so is environmental protected. The present disclosure is fit for mass production.

### CROSS REFERENCE TO RELATED PATENT APPLICATIONS

This application claims priority from Taiwan Patent Application No. 098115080 filed in the Taiwan Patent Office on May 7, 2009, entitled “Method of Fabricating Metal Nitrogen Oxide Thin Film Structure” and incorporates the Taiwan patent application in its entirety by reference.

### TECHNICAL FIELD

The present disclosure relates to fabricating a thin film structure; more particularly, relates to fabricating a corrosion-resistant, electric conductive and decorative thin film structure of titanium nitrogen oxide (TiON), tantalum nitrogen oxide(TaON) or zirconium nitrogen oxide (ZrON) through an environmental-protected process at low temperature with low cost.

### DESCRIPTION OF THE RELATED ART

Generally, for making a TiN thin film, a substrate is put into a nitrogen gas (N₂) environment. Then, titanium tetrachloride (TiCl₄) or ammonia (NH₃) is used as a reaction gas to coat a TiN thin film over on the substrate through chemical vapor deposition (CVD) and annealing. However, during the processes, a high temperature for deposition between 500° C. and 600° C. may make instability of substrate quality and impurity permeation happen while high-temperature energy consumption may be increased too. Hence, the prior art does not fulfill all users' requests on actual use.

### SUMMARY OF THE DISCLOSURE

The main purpose of the present disclosure is to fabricate a corrosion-resistant, electric conductive and decorative thin film structure of TiON, TaON or ZrON through an environmental-protected process at low temperature with low cost.

To achieve the above purpose, the present disclosure is a method of fabricating a metal nitrogen oxide thin film structure, comprising steps of: (a) selecting a substrate to be put into a vacuum environment; (b) coating a thin film of titanium (Ti), tantalum (Ta) or zirconium (Zr) over on the substrate through thermal evaporation deposition; (c) coating a 65 nm-thick silver protective film over on the substrate; (d) etching off the protective film by a mixture solution of ammonia water, hydrogen peroxide and water (xNH₄OH+yH₂O₂+zH₂O), which has a size ratio of x:y:z of 1:1:10 and reacting the mixture solution with the thin film to form a thin film of TiON, TaON or ZrON, respectively; and (e) processing the thin film through annealing for repairing lattice of the thin film. Accordingly, a novel method of fabricating a metal nitrogen oxide thin film structure is obtained.

### BRIEF DESCRIPTION OF THE DRAWINGS

The present disclosure will be better understood from the following detailed description of the preferred embodiment according to the present disclosure, taken in conjunction with the accompanying drawings, in which

FIG. 1 is the flow view showing the preferred embodiment according to the present disclosure;

FIG. 2 is the view showing the flow of fabricating the TiON thin film structure;

FIG. 3A and FIG. 3B are the views showing the flow of fabricating the TaON thin film structure;

FIG. 4 is the view showing the flow of fabricating the ZrON thin film structure;

FIG. 5A to FIG. 5D are the views showing the qualitative and quantitative characteristics of TiON fabricated accordingly;

FIG. 6A to FIG. 6D are the view showing the qualitative and quantitative characteristics of TaON fabricated accordingly; and

FIG. 7A to FIG. 7D are the view showing the qualitative and quantitative characteristics of ZrON fabricated accordingly.

### DESCRIPTION OF THE PREFERRED EMBODIMENT

The following description of the preferred embodiment is provided to understand the features and the structures of the present disclosure.

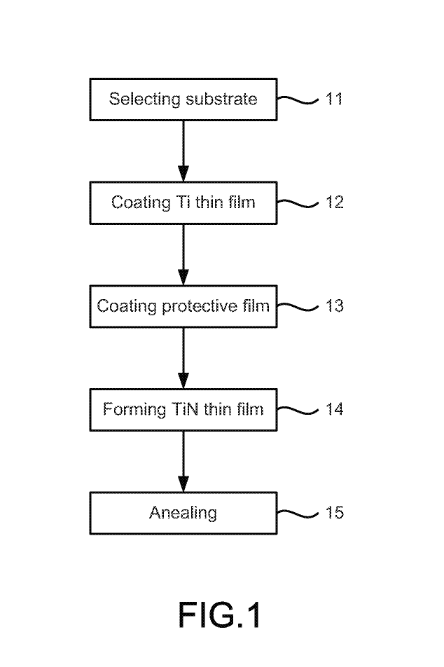

Please refer to FIG. 1 , which is a flow view showing a preferred embodiment according to the present disclosure. As shown in the figure, the present disclosure is a method of fabricating a metal nitrogen oxide thin film structure, comprising the following steps:

(a) Selecting substrate 11: A substrate is selected and is put into a vacuum environment, where the substrate is made of stainless steel, ceramic, plastic, polymer or glass.

(b) Coating metal thin film 12: A thin film of a metal having a thickness between 1 nanometers (nm) and 5000 nm is coated over on the substrate through a deposition method, which the metal is titanium (Ti), tantalum (Ta) or zirconium (Zr).

(c) Coating protective film 13: A protective film of sliver (Ag) having a thickness between 1 nm and 200 nm is coated over on the thin film through a deposition method to prevent oxidation of the metal thin film.

(d) Forming metal nitrogen oxide thin film 14: The protective film is etched off by a mixture solution of ammonia water, hydrogen peroxide and water (xNH₄OH+yH₂O₂+zH₂O), where the mixture solution has a size ratio of x:y:z between 1:1:1 and 1:1:100. The mixture solution is further reacted with the metal thin film to form a thin film of titanium nitrogen oxide (TiON), tantalum nitrogen oxide (TaON) or zirconium nitrogen oxide (ZrON).

(e) Annealing 15: At last, the metal nitrogen oxide thin film is processed through annealing to repair lattice of the TiON, TaON or ZrON thin film for forming a TiON , TaON or ZrON thin film structure.

Therein, the metal thin film and the protective film are coated over on the substrate through e-gun deposition method, thermal evaporation deposition method, sputtering deposition method, electroplating deposition method or electroless deposition method; and the annealing is processed at a temperature between 450 Celsius degrees (° C.) and 800° C. in an environment of nitrogen (N), an environment of hydrogen (H), an environment of a mixture gas of nitrogen and hydrogen, or a environment of non-oxygen vacuum. Thus, a novel method of fabricating a metal nitrogen oxide thin film structure is obtained.

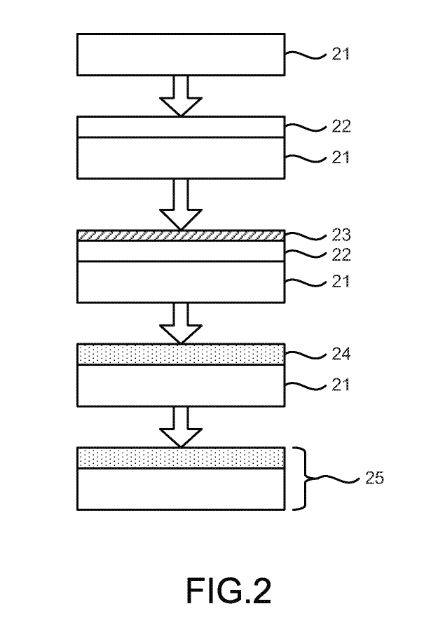

Please refer to FIG. 2, which is a view showing a flow of fabricating a TiON thin film structure. As shown in the figure, on using the present disclosure, a substrate 21 made of stainless steel, ceramic, plastic, polymer or glass is put into a vacuum environment. Then, the substrate 21 is coated with a Ti thin film 22 then a protective film 23 both through thermal evaporation deposition, where the protective film 23 is an Ag thin film and has a 65 nm thickness. Then, the protective film 23 is etched off by a mixture solution of xNH₄OH+yH₂O₂+zH₂O; and the mixture solution is reacted with the Ti thin film 22 to form a TiON thin film 24, where the mixture solution of xNH₃+yH₂O₂+zH₂O has a 1:1:10 size ratio of x:y:z. At last, the TiON thin film 24 is processed through annealing to repair lattice of the TiON thin film 24 for forming a TiON thin film structure 25.

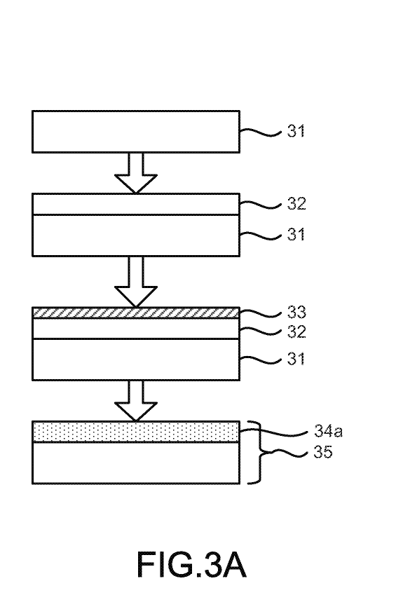

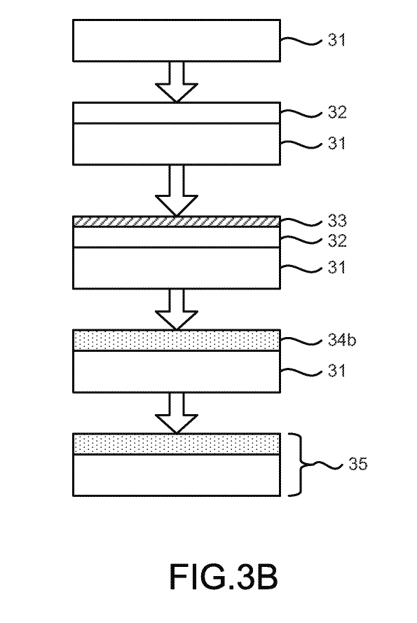

Please refer to FIG. 3A and FIG. 3B, which are views showing flows of fabricating a TaON thin film structure. As shown in FIG. 3A, on using the present disclosure, a substrate 31 is put into a vacuum environment. Then, the substrate is coated with a Ta thin film 32 then an Ag thin film 33 both through thermal evaporation deposition, where the Ag thin film 33 has a 65 nm thickness. Then, the Ag thin film 33 is etched off by a mixture solution of xN H₄O H+yH₂O₂+zH₂O; and the mixture solution is reacted with the Ta thin film 32 to form a TaON thin film 34, where the mixture solution of xNH₃+yH₂O₂+zH₂O has a 1:1:10 size ratio of x:y:z. Thus, a TaON thin film structure 35 is formed.

As shown in FIG. 3B, the TaON thin film 34 is further processed through annealing to repair lattice of the TaON thin film 34 for forming the TaON thin film structure 35.

Thus, the TaON thin film 34 may or may not be further processed through annealing for forming the TaON thin film structure 35 according to request.

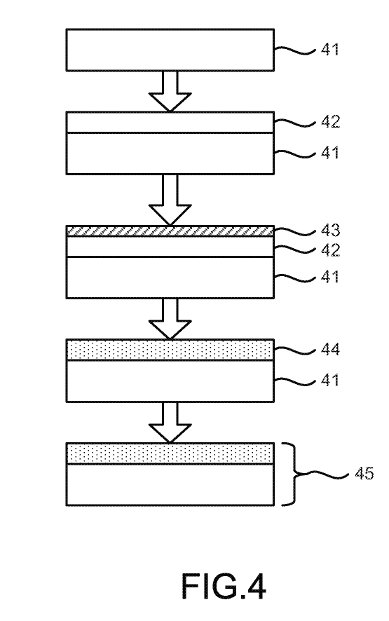

Please refer to FIG. 4, which is a view showing a flow of fabricating a ZrON thin film structure. As shown in the figure, on using the present disclosure, a substrate 41 is put into a vacuum environment. Then, the substrate 41 is coated with a Zr thin film 42 then an Ag thin film 43 both through thermal evaporation deposition, where the Ag thin film 43 has a 65 nm thickness. Then, the Ag thin film 43 is etched off by a mixture solution of xNH₄OH+yH₂O₂+zH₂O; and the mixture solution is reacted with the Zr thin film 42 to form a ZrON thin film 44, where the mixture solution of xNH₃+yH₂O₂+zH₂O has a 1:1:10 size ratio of x:y:z. At last, the ZrON thin film is processed through annealing to repair lattice of the ZrON thin film 44 for forming a ZrON thin film structure 45.

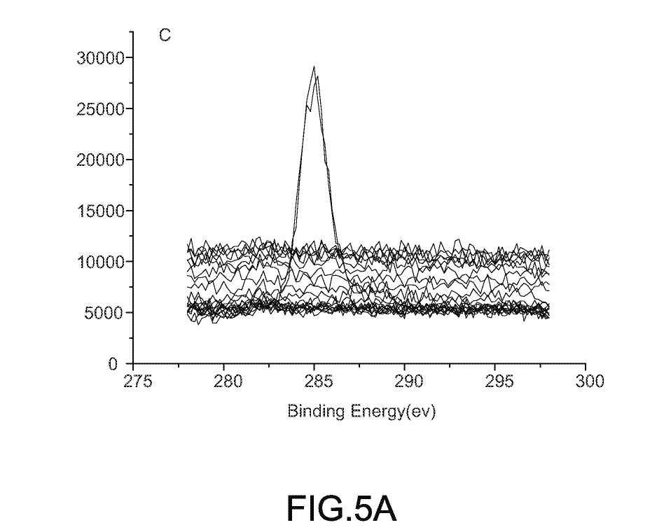

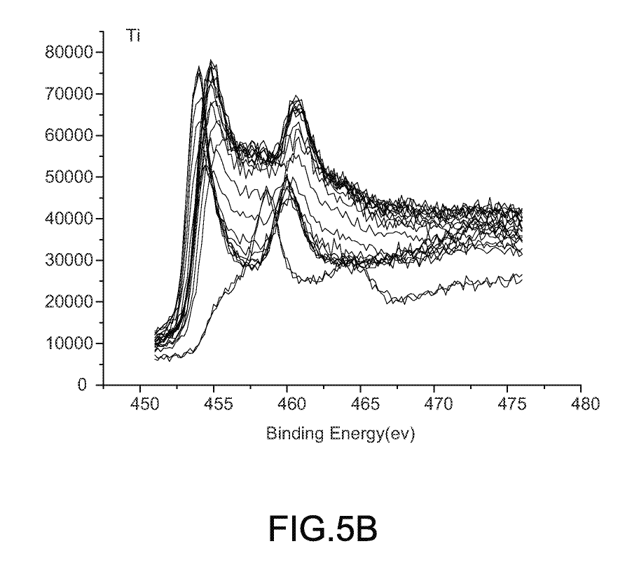

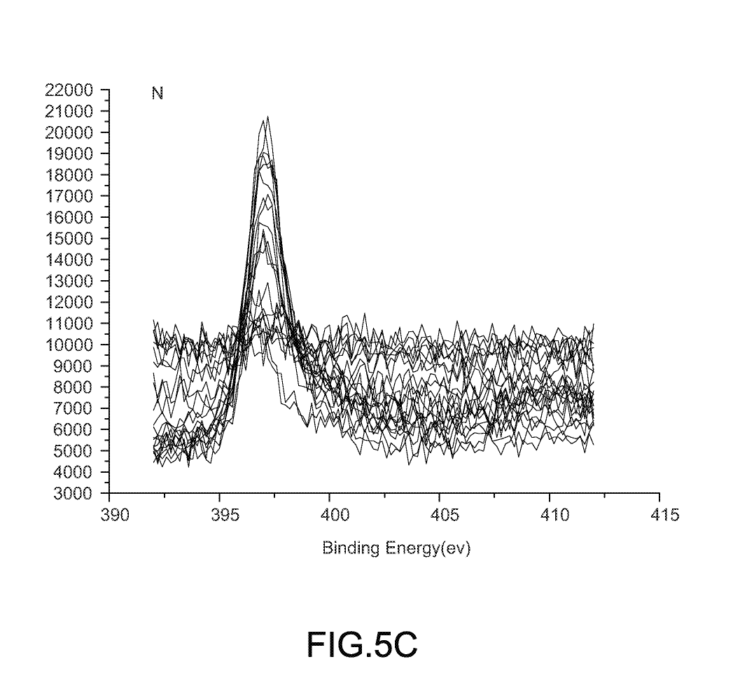

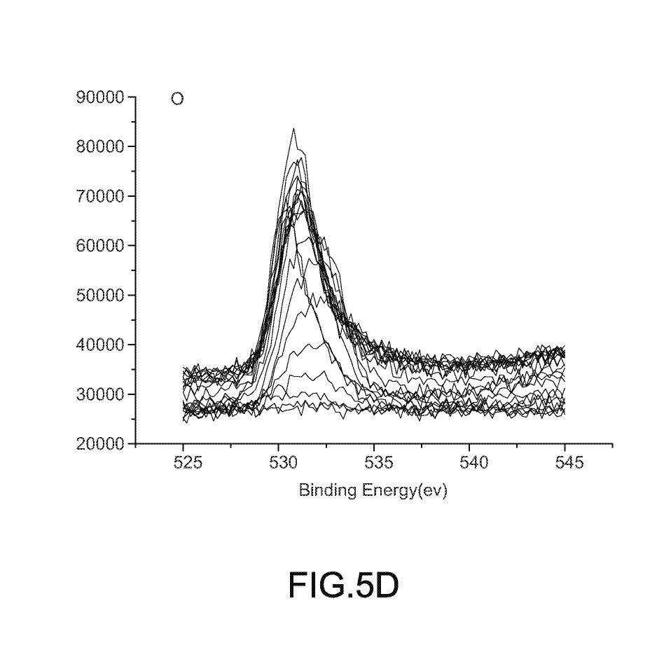

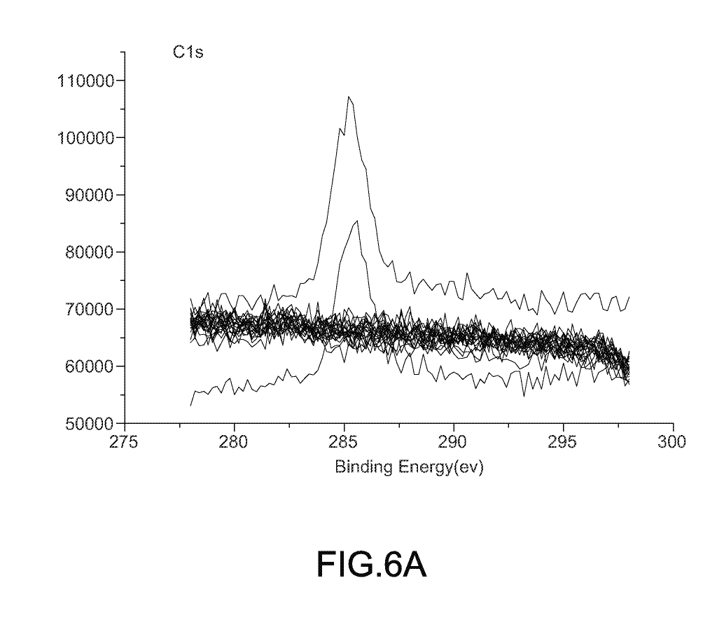

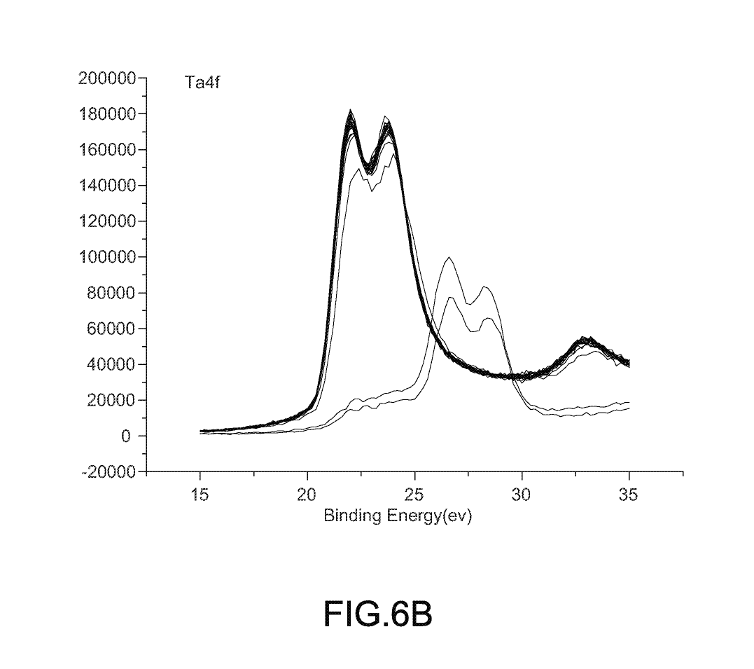

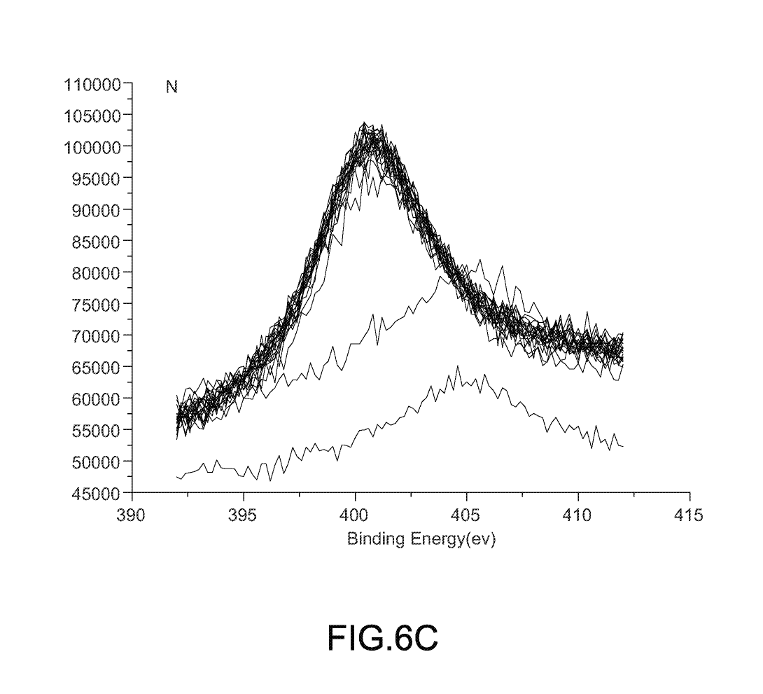

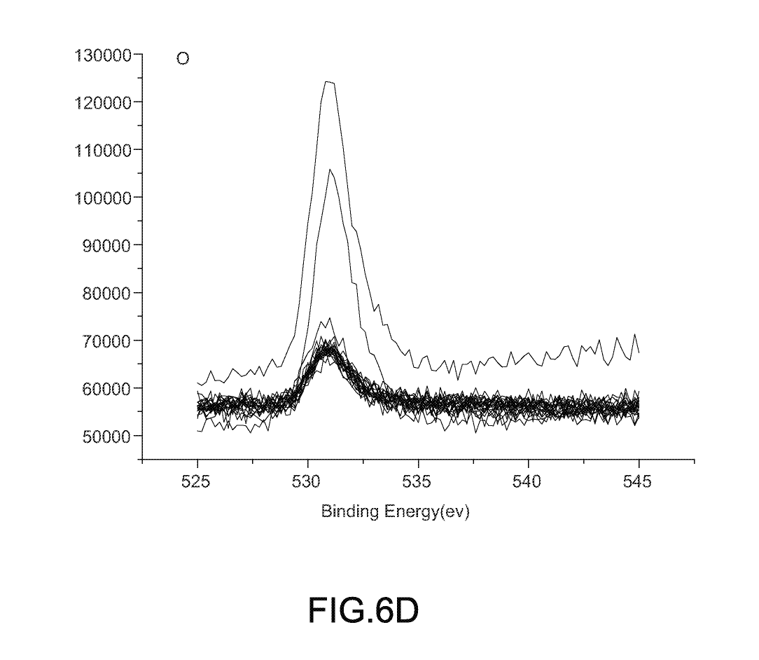

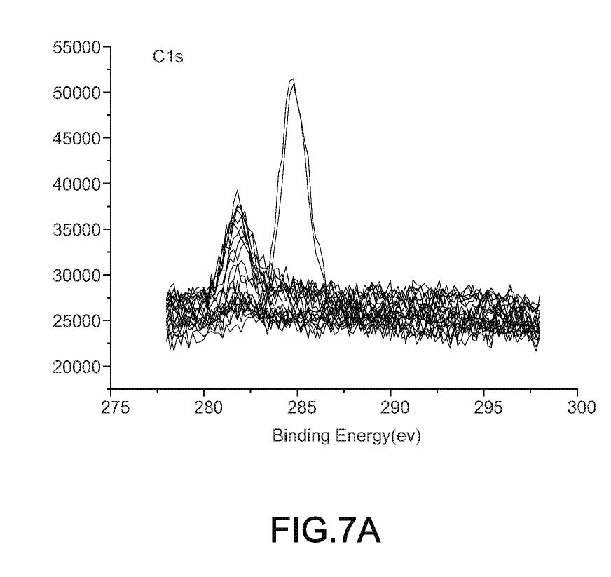

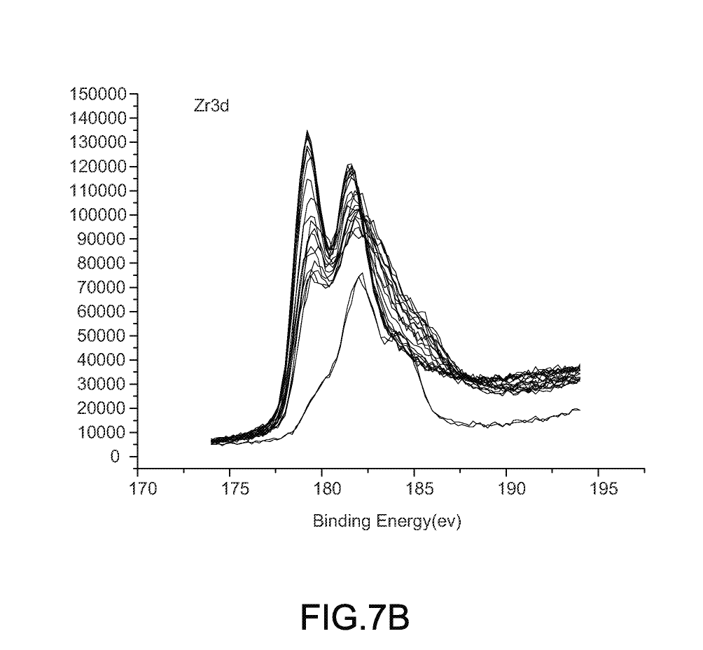

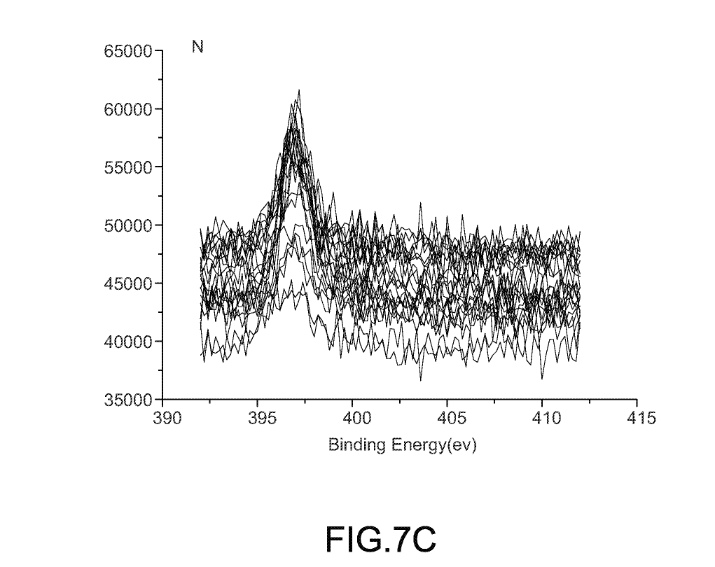

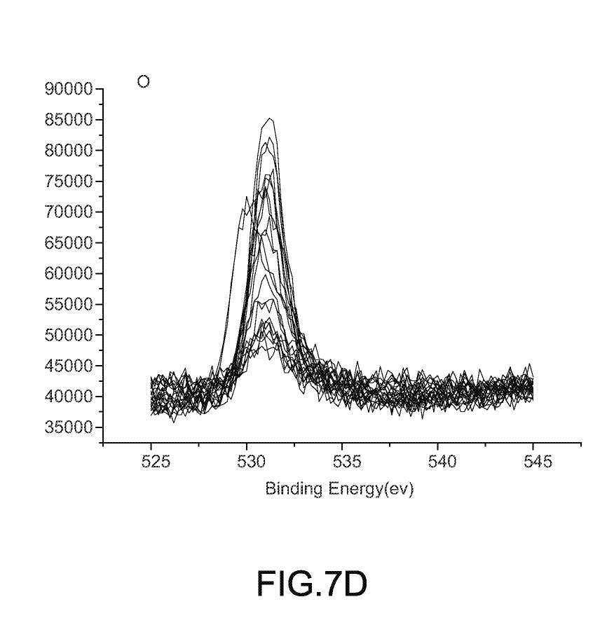

Please refer to FIG. 5A to FIG. 7D, which are views showing the qualitative and quantitative characteristics of TiON, TaON and ZrON fabricated accordingly. As shown in the figures, the TiON, TaON and ZrON fabricated according to the present disclosure are analyzed by X-ray photoelectron spectroscopy (XPS). As results show, Ti is confirmed to be bonded with N in TiON (shown in FIG. 5A to FIG. 5D); Ta is confirmed to be bonded with N and O in TaON (shown in FIG. 6A to FIG. 6D); and, Zr is confirmed to be bonded with N and O in ZrON (shown in FIG. 7A to FIG. 7D). Thus, the present disclosure fabricates a TiON, TaON or ZrON thin film having corrosion-resistant characteristic, electric conductivity and decoration function; and so is fit for mass production through simple processes at low temperature with low cost. Furthermore, the present disclosure uses no chloride (Cl) and thus is environmental protected.

To sum up, the present disclosure is a method of fabricating a metal nitrogen oxide thin film structure, where the metal nitrogen oxide thin film thus fabricated is corrosion-resistant, electric conductive and decorative; and the present disclosure is fit for mass production through simple processes at low temperature with low cost and is environmental protected with no chloride (Cl) used during the fabrication process.

The preferred embodiment herein disclosed is not intended to unnecessarily limit the scope of the disclosure.

Therefore, simple modifications or variations belonging to the equivalent of the scope of the claims and the instructions disclosed herein for a patent are all within the scope of the present disclosure.

What is claimed is:

1. A method of fabricating a metal nitrogen oxide thin film structure, comprising steps of:
(a) obtaining a substrate and putting said substrate into a vacuum environment;
(b) coating a thin film of a metal over on said substrate through a deposition method,
wherein said metal is selected from a group consisting of titanium (Ti), tantalum (Ta) and zirconium (Zr);
(c) coating a protective film over on said metal thin film through a deposition method to prevent oxidation of said metal thin film;
(d) etching off said protective film with a mixture solution of ammonia water, hydrogen peroxide and water (xNH₃+yH₂O₂+zH₂O) and reacting said mixture solution with said metal thin film to obtain a thin film selected from a group consisting of titanium nitrogen oxide (TiON) thin film, tantalum nitrogen oxide (TaON) thin film and zirconium nitrogen oxide (ZrON) thin film, respectively; and
(e) processing said metal nitrogen oxide thin film through annealing to repair lattice and thus obtain a metal nitrogen oxide thin film structure.

2. The method according to claim 1, wherein, in step (a), said substrate is made of a material selected from a group consisting of stainless steel, ceramic, plastic, polymer and glass.

3. The method according to claim 1, wherein, in step (b), said metal thin film has a thickness between 1 nanometers (nm) and 5000 nm.

4. The method according to claim 1, wherein, in step (c), said protective film is a silver (Ag) thin film having a thickness between 1 nm and 200 nm.

5. The method according to claim 4, wherein said Ag thin film has a thickness of 65 nm.

6. The method according to claim 1, wherein, in step (b) and step (c), said deposition method is selected from a group consisting of e-gun deposition method, thermal evaporation deposition method, sputtering deposition method, electroplating deposition method and electroless deposition method.

7. The method according to claim 1, wherein, in step (d), said mixture solution of xNH₃+yH₂O₂+zH₂O has a size ratio of x:y:z between 1:1:1 and 1:1:100.

8. The method according to claim 7, wherein said size ratio of x:y:z is 1:1:10.

9. The method according to claim 1, wherein said metal nitrogen oxide thin film is processed through annealing at a temperature between 450 Celsius degrees (° C.) and 800° C. in an environment selected from a group consisting of an environment of nitrogen;
an environment of hydrogen; an environment of a mixture gas of nitrogen and hydrogen; and a environment of non-oxygen vacuum.

10. The method according to claim 1, wherein said metal nitrogen oxide thin film structure having TaON thin film is obtained without processing said annealing in step (d).
